(19) United States
(12) Patent Application Publication
(10) Pub. No.: US 2025/0303287 A1
(43) Pub. Date: Oct. 2, 2025

(54) GAME SYSTEM AND GAME PROCESSING METHOD

(71) Applicant: NINTENDO CO., LTD., Kyoto (JP)

(72) Inventors: Koichi KAWAMOTO, Kyoto (JP); Toshiaki SUZUKI, Kyoto (JP)

(21) Appl. No.: 19/089,799

(22) Filed: Mar. 25, 2025

(30) Foreign Application Priority Data
Apr. 2, 2024 (JP) 2024-059581

(51) Int. Cl. A63F 13/52

(52) U.S. Cl. CPC A63F 13/52

(57) ABSTRACT

An information processing system includes a parent apparatus and a plurality of child apparatuses. The parent apparatus acquires parent apparatus operation data relating to an operation on an operation device of the parent apparatus and acquires child apparatus operation data from each of the plurality of child apparatuses. The parent apparatus performs game processing based on the parent apparatus operation data and the received child apparatus operation data and generates a first image and a plurality of second images based on the game processing. The parent apparatus outputs the first image to a display device of the parent apparatus and transmits the generated second images to the child apparatuses. Each of the child apparatuses transmits the child apparatus operation data relating to an operation on an operation device of the child apparatus to the parent apparatus and outputs the second image received from the parent apparatus to a display device.

### CROSS REFERENCE TO RELATED APPLICATION

This application claims priority to Japanese Patent Application No. 2024-059581 filed on Apr. 2, 2024, the entire contents of which are incorporated herein by reference.

### FIELD

An exemplary embodiment relates to a game system including a plurality of information processing apparatuses and a game processing method.

### BACKGROUND AND SUMMARY

Conventionally, there is a technique in which one of a plurality of information processing apparatuses is set as a parent apparatus, the other apparatuses are set as child apparatuses, and the parent apparatus distributes images to the child apparatuses, whereby a game is performed between the plurality of information processing apparatuses.

However, there is room for performing a game by a greater variety of methods using an information processing system having the function of distributing images from a parent apparatus to child apparatuses.

An exemplary embodiment discloses an information processing system having the function of distributing images from a parent apparatus to child apparatuses and capable of performing a game by a variety of new methods.

The exemplary embodiment employs the following configurations.

### First Configuration

A first configuration is a game system including a plurality of information processing apparatuses including a parent apparatus and a plurality of child apparatuses. Each of the plurality of information processing apparatuses includes: one or more processors; and one or more non-transitory computer-readable media having stored therein instructions that, when executed, cause the one or more processors to execute information processing including: among a plurality of play forms, in a first play form, performing a process relating to an operation input to an operation device included in the information processing apparatus and outputting an image to a display device included in the information processing apparatus, in a second play form, performing a process relating to an operation input to an operation device externally connected to the information processing apparatus and outputting an image to a display device externally connected to the information processing apparatus, and in a third play form, performing a process relating to an operation input to the operation device externally connected to the information processing apparatus and outputting an image to the display device included in the information processing apparatus; and communicating with another information processing apparatus in a plurality of communication forms including transmission and reception via the Internet and in a wireless manner. The game processing in the parent apparatus among the plurality of information processing apparatuses further includes: regarding a multiplay game in a predetermined play form among the plurality of play forms, performing the communication with each of the child apparatuses in the communication form set for the game among the plurality of communication forms; acquiring first operation data based on an input to the operation device relating to the play form; acquiring second operation data received from each of the child apparatuses; performing game processing regarding the game based on the first operation data and the second operation data; generating a first image and a plurality of second images different from the first image based on the game processing; outputting the first image to the display device relating to the play form; and transmitting the second images to the child apparatuses. The game processing in each of the child apparatuses further includes: performing the communication with the parent apparatus; transmitting the second operation data based on an input to the operation device relating to the play form to the parent apparatus; and outputting the second image received from the parent apparatus to the display device relating to the play form.

Based on the above, a game system including a parent apparatus and a plurality of child apparatuses can be configured using information processing apparatuses having various play forms and communication forms, and a large number of people can perform a game by the parent apparatus performing game processing. Consequently, it is possible to perform a game by a variety of methods.

### Second Configuration

According to a second configuration, in the first configuration, the game processing in the parent apparatus may further include: based on the first operation data, selecting an item configured to be selected by a player of the parent apparatus in the game; based on the second operation data of each of the child apparatuses, selecting an item configured to be selected by a player of the child apparatus in the game; and causing the game to progress based on each of the selected items. Each of the first image and the second images may include an image representing the item configured to be selected by the player relating to the game, and may not include images representing the items configured to be selected by the other players.

Based on the above, the parent apparatus alone executes game processing, whereby it is possible to execute a game that progresses by hiding an item of a player from an opponent.

### Third Configuration

According to a third configuration, in the second configuration, the game may be a competition table game. The image representing the item configured to be selected by the player may be an image of a hand of the player in the competition table game.

Based on the above, the parent apparatus alone executes game processing, whereby it is possible to perform a competition table game.

### Fourth Configuration

According to the fourth configuration, in the third configuration, the competition table game may be at least any of a card game that uses cards including playing cards, a mahjong game, and a hanafuda game. Each of the first image and the second images may at least include an image representing cards or tiles in hand of the corresponding player, and may not include an image representing cards and tiles in hand of the other players.

Based on the above, it is possible to perform various games as a competition table game.

### Fifth Configuration

According to the fifth configuration, in the first configuration, the game may be a game performed in the first or third play form and the communication form in a wireless manner. The game processing in the parent apparatus may further include generating images based on virtual cameras different from each other in a common virtual space as the first image and the second images.

Based on the above, it is possible to perform a game in a common virtual space using the parent apparatus and the plurality of child apparatuses.

### Sixth Configuration

According to the sixth configuration, in the fifth configuration, the game processing in the parent apparatus may further include: identifying positional relationships between the plurality of information processing apparatuses; and generating the first image and the second images based on the virtual cameras placed in accordance with the positional relationships.

Based on the above, it is possible to generate images based on the positional relationships between a plurality of information processing apparatuses.

### Seventh Configuration

According to a seventh configuration, in the sixth configuration, each of the plurality of information processing apparatuses may further include a touch panel provided in the display device included in the information processing apparatus. The game processing in each of the child apparatuses may further include transmitting child apparatus touch input data relating to an input to the touch panel of the child apparatus to the parent apparatus, and the game processing in the parent apparatus may further include: acquiring parent apparatus touch input data relating to an input to the touch panel of the parent apparatus; acquiring the child apparatus touch input data received from the child apparatus; and based on the parent apparatus touch input data and the child apparatus touch input data, identifying the positional relationships between the plurality of information processing apparatuses so that if a slide input across the touch panels of the information processing apparatuses is provided, places where the slide input is provided are adjacent to each other.

Based on the above, it is possible to identify the positional relationships between the plurality of information processing apparatuses based on a touch operation on a touch panel.

### Eighth Configuration

According to an eighth configuration, in any of the first, fifth, and sixth configurations, each of the plurality of information processing apparatuses may include a proximity sensing section that senses a state where the information processing apparatuses are in proximity to each other. The game processing in the parent apparatus may further include in accordance with the sensing of the state where the information processing apparatuses are in proximity to each other, starting transmission of the second images to the child apparatuses.

Based on the above, a child apparatus is brought close, whereby it is possible to start the transmission of second images to the child apparatuses.

### Ninth Configuration

According to a ninth configuration, in the eighth configuration, the proximity sensing section may perform the sensing through short-range communication or ultra-wideband wireless communication.

Based on the above, it is possible to sense the proximity between information processing apparatuses using short-range communication or ultra-wide band wireless communication.

### Tenth Configuration

According to a tenth configuration, in the ninth configuration, the game processing in the parent apparatus may further include identifying positional relationships between the plurality of information processing apparatuses based on the sensing of the proximity sensing section and generating the first image and the second images based on virtual cameras placed in accordance with the positional relationships.

Based on the above, it is possible to identify the positional relationships between a plurality of information processing apparatuses based on the sensing of proximity by proximity sensing sections.

According to the exemplary embodiment, a game system including a parent apparatus and a plurality of child apparatuses can be configured using information processing apparatuses having various play forms and communication forms. Thus, it is possible to perform a game by a variety of methods.

These and other features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is an example non-limiting diagram showing an example of an information processing apparatus 1 in the state where a left controller 3 and a right controller 4 are attached to a main body apparatus 2;

FIG. 2 is an example non-limiting diagram showing an example of the information processing apparatus 1 in the state where the left controller 3 and the right controller 4 are detached from the main body apparatus 2;

FIG. 3 is an example non-limiting block diagram showing an example of the internal configuration of the information processing apparatus 1;

FIG. 4 is an example non-limiting diagram showing an example of a game system 10 and is an example non-limiting diagram showing an overview of the game system 10 configured by a plurality of information processing apparatuses 1 performing local communication with each other;

FIG. 5 is an example non-limiting diagram showing an example of the game system 10 and is an example non-limiting diagram showing an overview of the game system 10 configured by the plurality of information processing apparatuses 1 performing Internet communication with each other;

FIG. 6A is an example non-limiting diagram showing an example of a game image displayed on a display 12a of an information processing apparatus 1a in a case where a mahjong game is performed as a first type of game;

FIG. 6B is an example non-limiting diagram showing an example of a game image displayed on a display 12b of an information processing apparatus 1b in a case where the mahjong game is performed as the first type of game;

FIG. 6C is an example non-limiting diagram showing an example of a game image displayed on a display 12c of an information processing apparatus 1c in a case where the mahjong game is performed as the first type of game;

FIG. 6D is an example non-limiting diagram showing an example of a game image displayed on a display 12d of an information processing apparatus 1d in a case where the mahjong game is performed as the first type of game;

FIG. 7 is an example non-limiting diagram showing an example of the placement of four main body apparatuses 2a to 2d in a case where a second type of game is performed;

FIG. 8 is an example non-limiting diagram showing an overview of a positional relationship identification process;

FIG. 9A is an example non-limiting diagram showing an example of a game image displayed on the display 12a of the main body apparatus 2a at a time T1 during the execution of the second type of game;

FIG. 9B is an example non-limiting diagram showing an example of a game image displayed on the display 12b of the main body apparatus 2b at the time T1;

FIG. 9C is an example non-limiting diagram showing an example of a game image displayed on the display 12c of the main body apparatus 2c at the time T1;

FIG. 9D is an example non-limiting diagram showing an example of a game image displayed on the display 12d of the main body apparatus 2d at the time T1;

FIG. 10A is an example non-limiting diagram showing an example of a game image displayed on the display 12a at a time T2 after the lapse of a predetermined time from the time T1;

FIG. 10B is an example non-limiting diagram showing an example of a game image displayed on the display 12b at the time T2 after the lapse of the predetermined time from the time T1;

FIG. 10C is an example non-limiting diagram showing an example of a game image displayed on the display 12c at the time T2 after the lapse of the predetermined time from the time T1;

FIG. 10D is an example non-limiting diagram showing an example of a game image displayed on the display 12d at the time T2 after the lapse of the predetermined time from the time T1;

FIG. 11 is an example non-limiting diagram showing an example of data stored in a parent apparatus;

FIG. 12 is an example non-limiting diagram showing an example of data stored in a child apparatus;

FIG. 13 is an example non-limiting flow chart showing an example of a parent apparatus process performed by the parent apparatus when a predetermined game is performed in the game system 10; and

FIG. 14 is an example non-limiting flow chart showing an example of a child apparatus process performed by the child apparatus.

### DETAILED DESCRIPTION OF NON-LIMITING EXAMPLE EMBODIMENTS

### (Description of Information Processing Apparatus)

An information processing apparatus used in an example of an exemplary embodiment is described below. An example of an information processing apparatus 1 includes a main body apparatus 2, a left controller 3, and a right controller 4. Each of the left controller 3 and the right controller 4 is configured to be attachable to and detachable from the main body apparatus 2. That is, the information processing apparatus 1 can be used as a unified apparatus obtained by attaching the left controller 3 and the right controller 4 to the main body apparatus 2. Further, the information processing apparatus 1 can also be used by detaching the left controller 3 and the right controller 4 from the main body apparatus 2. Hereinafter, the configuration of the information processing apparatus 1 according to the exemplary embodiment is described, and then, a game system including a plurality of information processing apparatuses 1 is described.

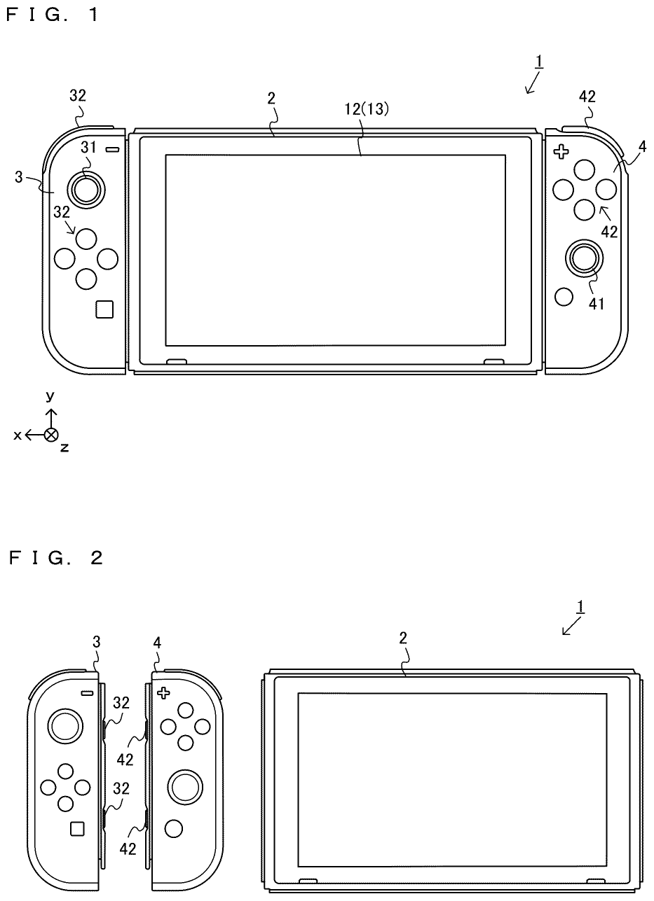

FIG. 1 is a diagram showing an example of the information processing apparatus 1 in the state where the left controller 3 and the right controller 4 are attached to the main body apparatus 2. FIG. 2 is a diagram showing an example of the information processing apparatus 1 in the state where the left controller 3 and the right controller 4 are detached from the main body apparatus 2. As shown in FIG. 1, each of the left controller 3 and the right controller 4 is attached to and unified with the main body apparatus 2. The main body apparatus 2 is an apparatus for performing various processes (e.g., game processing) in the information processing apparatus 1.

The main body apparatus 2 includes a display 12. The display 12 displays an image generated by the main body apparatus 2. The display 12 may be a display device of any type. For example, the display 12 may be a liquid crystal display device (LCD), or may be an organic EL display device.

Further, the main body apparatus 2 includes a touch panel 13 on a screen of the display 12. In the exemplary embodiment, the touch panel 13 is of a type that allows a multi-touch input (e.g., a capacitive type). The touch panel 13, however, may be of any type. For example, the touch panel 13 may be of a type that allows a single-touch input (e.g., a resistive type).

Each of the left controller 3 and the right controller 4 has a vertically long shape (i.e., a long shape in a y-axis direction shown in FIG. 1). In the state where each of the left controller 3 and the right controller 4 is detached from the main body apparatus 2, the controller can be held in the orientation in which the controller is vertically long, and can also be held in the orientation in which the controller is horizontally long.

The left controller 3 includes an analog stick 31 for a user to provide a direction input, and a plurality of operation buttons 32 for the user to perform a pressing operation. The right controller 4 includes an analog stick 41 for the user to provide a direction input, and a plurality of operation buttons 42 for the user to perform a pressing operation. Each of the left controller 3 and the right controller 4 may include an acceleration sensor and an angular velocity sensor within and be able to detect the motion and the orientation of the controller. Hereinafter, the left controller 3 and the right controller 4 are occasionally collectively referred to as a “first controller”.

The main body apparatus 2 to which the left controller 3 and the right controller 4 are attached (the information processing apparatus 1) is of a size that can be carried by the user. For example, the user performs a game operation using the left controller 3 and the right controller 4 by holding the left controller 3 unified with the main body apparatus 2 with their left hand and holding the right controller 4 unified with the main body apparatus 2 with their right hand and plays a game while viewing a game image displayed on the display 12 in front of the user. Hereinafter, a play form in which as described above, in the state where the left controller 3 and the right controller 4 are attached to the main body apparatus 2, the user performs a game operation using the left controller 3 and the right controller 4 and plays a game while viewing a game image displayed on the display 12 is occasionally referred to as a “mobile mode”.

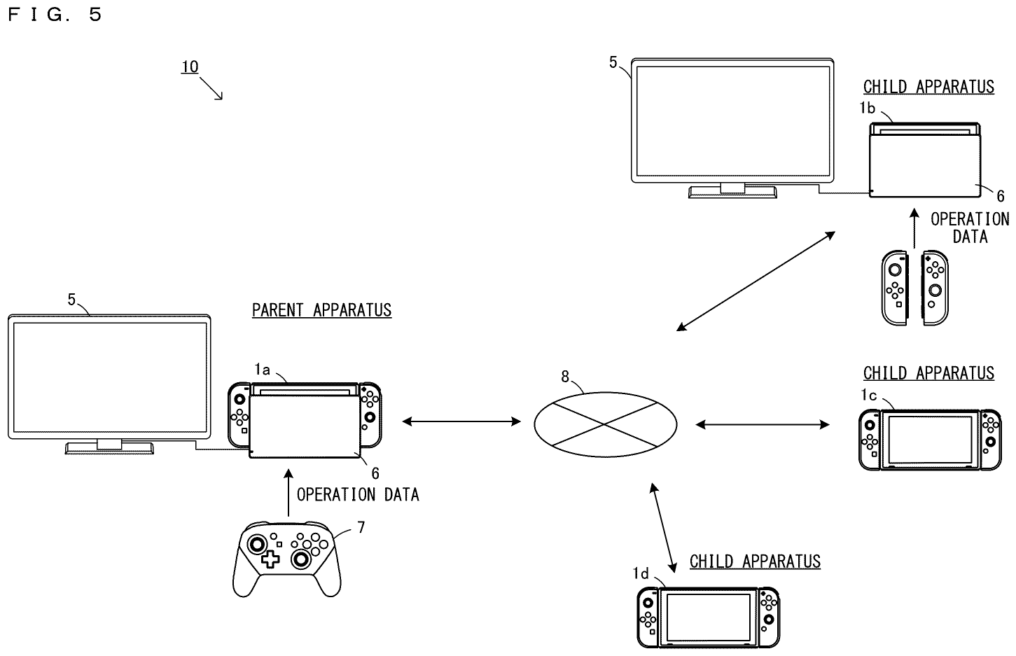

As shown in FIG. 2, the left controller 3 and the right controller 4 can be detached from the main body apparatus 2. In the state where the left controller 3 and the right controller 4 are detached from the main body apparatus 2, the left controller 3 and the right controller 4 are wirelessly connected to the main body apparatus 2. For example, a stand for standing the main body apparatus 2 is provided on a back surface of the main body apparatus 2. Using the stand, the user can place the main body apparatus 2 in the state where the main body apparatus 2 stands on a table so that the screen of the display 12 is almost perpendicular to the table. Alternatively, the user may place the main body apparatus 2 on the table so that the screen of the display 12 of the main body apparatus 2 faces up. The user can detach the left controller 3 and the right controller 4 from the main body apparatus 2, perform a game operation using the left controller 3 and/or the right controller 4, and play a game while viewing a game image displayed on the display 12 of the main body apparatus 2 placed on the table. Hereinafter, a play form in which as described above, the left controller 3 and the right controller 4 are wirelessly connected to the main body apparatus 2, and the user performs a game operation using the left controller 3 and/or the right controller 4 and plays a game while viewing a game image displayed on the display 12 is occasionally referred to as a “table mode”. To the main body apparatus 2, a second controller 7 (see FIG. 5) different from the left controller 3 and the right controller 4 may be able to be wirelessly connected. The second controller may be a controller that can be operated by the user by holding the controller with both hands. A play form in which as described above, the second controller is wirelessly connected to the main body apparatus 2, and the user performs a game operation using the second controller and plays a game while viewing a game image displayed on the display 12 is also referred to as a “table mode”. Hereinafter, the first controller and the second controller are occasionally collectively referred to as a “controller”.

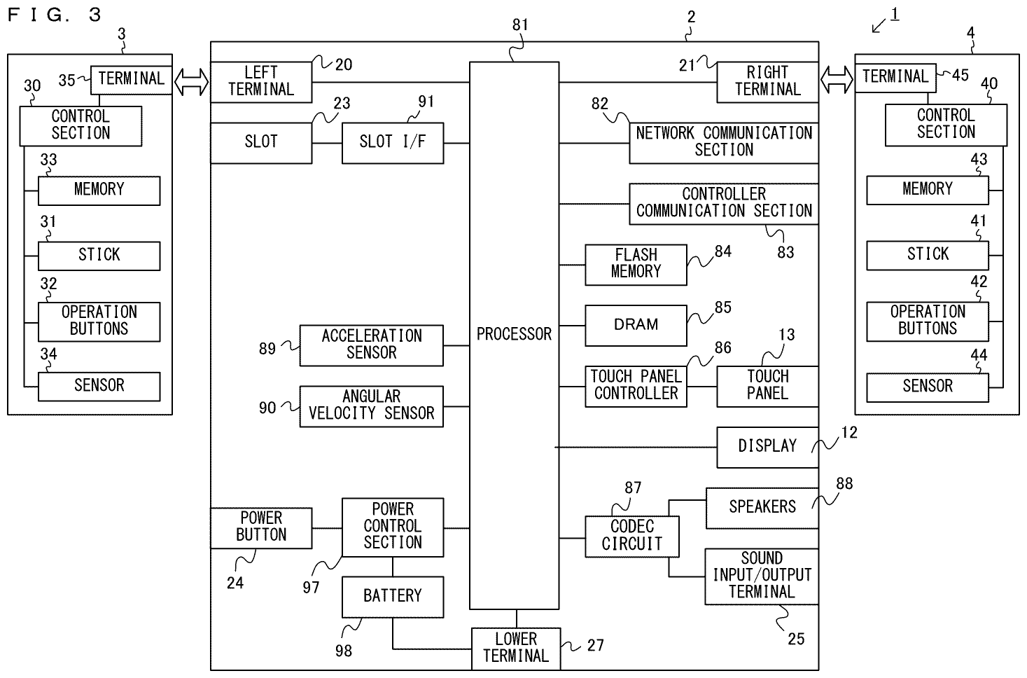

The user can also connect the main body apparatus 2 to a stationary monitor (e.g., television) 5 via a cradle 6 and play a game while viewing a game image displayed on the stationary monitor 5 (see FIG. 5). In the main body apparatus 2, a lower terminal 27 (see FIG. 3) for connecting to the cradle 6 is provided. The main body apparatus 2 is connected to the stationary monitor 5 in a wired manner via the cradle 6. A play form in which as described above, the user plays a game while viewing an image displayed on the external stationary monitor 5 different from the display 12 is occasionally referred to as a “stationary mode”. In a case where the information processing apparatus 1 operates in the stationary mode, the first controller (the left controller 3 and the right controller 4) may be detached from the main body apparatus 2 and wirelessly connected to the main body apparatus 2, and the user may perform a game operation using the first controller. Alternatively, in a case where the information processing apparatus 1 operates in the stationary mode, in the state where the left controller 3 and the right controller 4 are attached to the main body apparatus 2, another first controller or the second controller may be wirelessly connected to the main body apparatus 2, and the user may perform a game operation using the first controller or the second controller.

Next, the internal configuration of the information processing apparatus 1 is described. FIG. 3 is a block diagram showing an example of the internal configuration of the information processing apparatus 1.

As shown in FIG. 3, the main body apparatus 2 includes a processor 81. The processor 81 is an information processing section for executing various types of information processing to be executed by the main body apparatus 2. For example, the processor 81 may be composed of one or more CPUs (Central Processing Units), or may be composed of a SoC (System-on-a-chip) including one or more CPUs and one or more GPUs (Graphics Processing Units). The processor 81 executes an information processing program (e.g., a game program) stored in a storage section (specifically, an internal storage medium such as a flash memory 84, an external storage medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, the network communication section 82 can directly wirelessly communicate with another main body apparatus 2 present in the communication range of this main body apparatus 2 using a predetermined communication method (e.g., a communication method based on a unique protocol or a method compliant with the Wi-Fi standard). Via a wireless LAN access point present in the communication range of this main body apparatus 2, the network communication section 82 may also be able to communicate with another main body apparatus 2 connected to a local area network including the access point using a method compliant with the Wi-Fi standard. Here, such direct communication with another main body apparatus 2 and such communication in a local area network via a wireless LAN access point are referred to as “local communication”. The network communication section 82 can connect to the Internet by connecting to a wireless LAN using a method compliant with the Wi-Fi standard, and can communicate with another apparatus connected to the Internet. The main body apparatus 2 may be able to connect to a wired LAN, and may be able to connect to the Internet via the wired LAN. For example, the main body apparatus 2 may be able to connect to the wired LAN via the cradle 6. Here, such communication with another apparatus via the Internet is referred to as “Internet communication”.

The main body apparatus 2 includes a controller communication section 83. The controller communication section 83 is connected to the processor 81. The controller communication section 83 wirelessly communicates with the left controller 3 and/or the right controller 4. The controller communication section 83 can also wirelessly communicate with the second controller. The communication method between the main body apparatus 2 and the left controller 3 and the right controller 4 (or the second controller) is optional. In the exemplary embodiment, the controller communication section 83 performs communication compliant with the Bluetooth (registered trademark) standard with the left controller 3 and with the right controller 4.

The processor 81 is connected to a left terminal 20, a right terminal 21, and a lower terminal 27. When performing wired communication with the left controller 3, the processor 81 transmits data to the left controller 3 via the left terminal 20 and also receives operation data from the left controller 3 via the left terminal 20. Further, when performing wired communication with the right controller 4, the processor 81 transmits data to the right controller 4 via the right terminal 21 and also receives operation data from the right controller 4 via the right terminal 21. Further, when communicating with the cradle 6, the processor 81 transmits data to the cradle 6 via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle 6, the main body apparatus 2 can output data (e.g., image data or sound data) to the stationary monitor 5 or the like via the cradle 6.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of users can simultaneously provide inputs to the main body apparatus 2, each using a set of the left controller 3 and the right controller 4. As an example, a first user can provide an input to the main body apparatus 2 using a first set of the left controller 3 and the right controller 4, and simultaneously, a second user can provide an input to the main body apparatus 2 using a second set of the left controller 3 and the right controller 4.

The main body apparatus 2 includes a touch panel controller 86, which is a circuit for controlling the touch panel 13. The touch panel controller 86 is connected between the touch panel 13 and the processor 81. Based on a signal from the touch panel 13, the touch panel controller 86 generates, for example, data indicating the position where a touch input is provided. Then, the touch panel controller 86 outputs the data to the processor 81.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

Further, the main body apparatus 2 includes an acceleration sensor 89. In the exemplary embodiment, the acceleration sensor 89 detects the magnitudes of accelerations along predetermined three axial (e.g., xyz axes shown in FIG. 1) directions. It should be noted that the acceleration sensor 89 may detect an acceleration along one axial direction or accelerations along two axial directions.

Further, the main body apparatus 2 includes an angular velocity sensor 90. In the exemplary embodiment, the angular velocity sensor 90 detects angular velocities about predetermined three axes (e.g., the xyz axes shown in FIG. 1). It should be noted that the angular velocity sensor 90 may detect an angular velocity about one axis or angular velocities about two axes.

The acceleration sensor 89 and the angular velocity sensor 90 are connected to the processor 81, and the detection results of the acceleration sensor 89 and the angular velocity sensor 90 are output to the processor 81. Based on the detection results of the acceleration sensor 89 and the angular velocity sensor 90, the processor 81 can calculate information regarding the motion and/or the orientation of the main body apparatus 2.

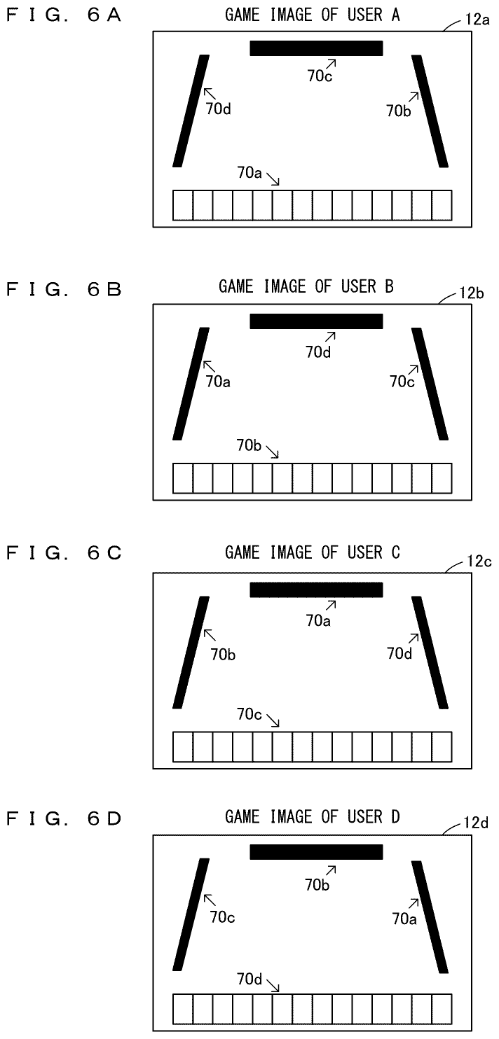

The main body apparatus 2 includes a power button 24, a power control section 97, and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 20, and the right terminal 21). Based on a command from the processor 81, the power control section 97 controls the supply of power from the battery 98 to the above components.

Further, the battery 98 is connected to the lower terminal 27. When an external charging device (e.g., the cradle 6) is connected to the lower terminal 27, and power is supplied to the main body apparatus 2 via the lower terminal 27, the battery 98 is charged with the supplied power.

The left controller 3 includes a terminal 35 that is connected to the left terminal 20 of the main body apparatus 2. The left controller 3 also includes a control section 30. The control section 30 is connected to components including the terminal 35. The control section 30 controls the method for communication performed by the left controller 3 with the main body apparatus 2. In the exemplary embodiment, the control section 30 can communicate with the main body apparatus 2 through both wired communication via the terminal 35 and wireless communication via an antenna (not shown). That is, when the left controller 3 is attached to the main body apparatus 2, the control section 30 communicates with the main body apparatus 2 via the terminal 35. Further, when the left controller 3 is detached from the main body apparatus 2, the control section 30 wirelessly communicates with the main body apparatus 2 (specifically, the controller communication section 83). The wireless communication between the controller communication section 83 and the control section 30 is performed in accordance with the Bluetooth (registered trademark) standard, for example.

Further, the left controller 3 includes a memory 33 such as a flash memory. The control section 30 includes, for example, a microcomputer (or a microprocessor) and executes firmware stored in the memory 33, thereby performing various processes.

The left controller 3 includes the analog stick (“stick” in FIG. 3) 31 and the plurality of operation buttons 32. Information regarding an operation performed on each of the analog stick 31 and the plurality of operation buttons 32 is output to the control section 30 repeatedly at appropriate timing.

Further, the left controller 3 includes a sensor 34. The sensor 34 includes an acceleration sensor and an angular velocity sensor. The acceleration sensor detects the magnitudes of accelerations along the xyz axis directions shown in FIG. 1, and the angular velocity sensor detects angular velocities about the xyz axes. The detection results of the acceleration sensor and the angular velocity sensor are output to the control section 30 repeatedly at appropriate timing.

The control section 30 acquires information regarding an input (specifically, information regarding an operation on each of the analog stick 31 and the operation buttons 32 or the detection result of the sensor 34) from each of the operation buttons 32, the analog stick 31, and the sensor 34. The control section 30 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can determine operations on the analog stick 31 and the operation buttons 32 based on the operation data. Further, based on the detection result of the sensor 34, the main body apparatus 2 can acquire information regarding the motion and/or the orientation of the left controller 3.

Although not shown in the figures, the left controller 3 includes a battery that supplies power to the above components. The left controller 3 may also include a vibrator.

As shown in FIG. 3, the right controller 4 includes a terminal 45 that is connected to the right terminal 21 of the main body apparatus 2, a control section 40, a memory 43, a stick 41, a plurality of operation buttons 42, and a sensor 44. These components have functions similar to those of the above components of the left controller 3, and therefore are not described.

### (Description of Game System Including Plurality of Information Processing Apparatuses)

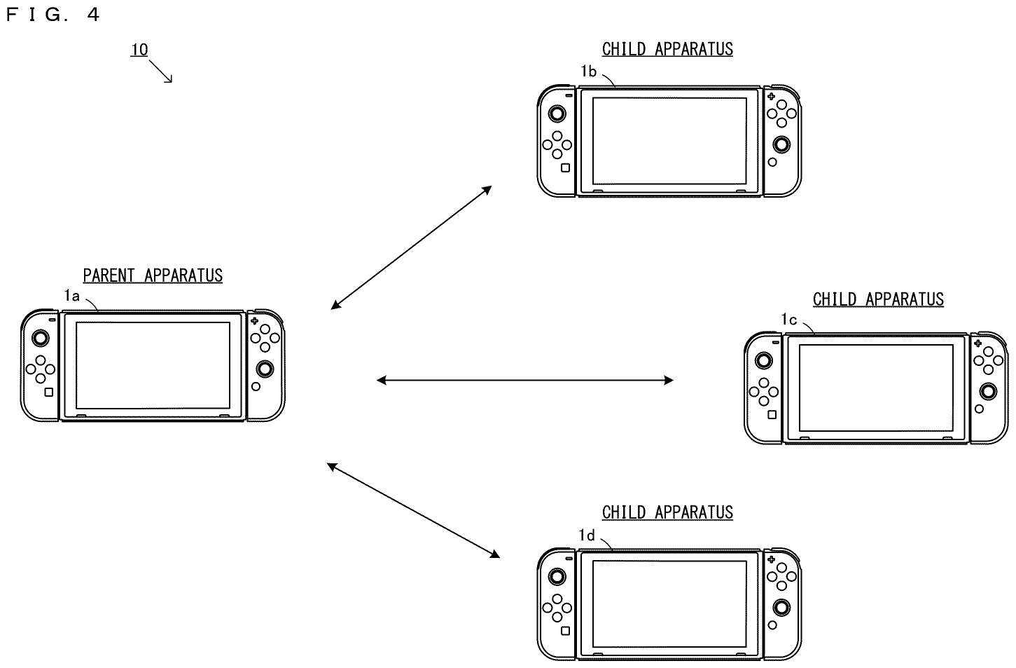

A description is given below of an example of a game system 10 for performing a game according to the exemplary embodiment described below. The game system 10 is a system configured by a plurality of information processing apparatuses 1 communicating with each other. FIG. 4 is a diagram showing an example of the game system 10 and is a diagram showing an overview of the game system 10 configured by the plurality of information processing apparatuses 1 performing the local communication with each other. FIG. 5 is a diagram showing an example of the game system 10 and is a diagram showing an overview of the game system 10 configured by the plurality of information processing apparatuses 1 performing the Internet communication with each other.

As shown in FIGS. 4 and 5, the game system 10 includes a plurality of information processing apparatuses 1. For example, the game system 10 includes an information processing apparatus 1a, an information processing apparatus 1b, an information processing apparatus 1c, and an information processing apparatus 1d.

Although FIGS. 4 and 5 exemplify cases where the game system 10 includes four information processing apparatuses 1, the number of information processing apparatuses 1 included in the game system 10 may be optional. In both the communication forms shown in FIGS. 4 and 5, the plurality of information processing apparatuses 1 included in the game system 10 may operate in the mobile mode, or may operate in the stationary mode, or may operate in the table mode, or these modes may coexist. For example, in the communication form shown in FIG. 4, all the information processing apparatuses 1a to 1d may operate in the mobile mode, or may operate in the stationary mode, or may operate in the table mode, or the mobile mode, the stationary mode, and the table mode may coexist. Although in the game system 10 shown in FIG. 5, information processing apparatuses in the stationary mode (1a and 1b) and information processing apparatuses in the mobile mode (1c and 1d) coexist, an information processing apparatus in the table mode may be included, or all the information processing apparatuses 1a to 1d may operate in the mobile mode, or may operate in the stationary mode, or may operate in the table mode.

In FIGS. 4 and 5, the information processing apparatus 1a functions as a parent apparatus. The information processing apparatus 1a as the parent apparatus executes a game program. The processor 81 of the information processing apparatus 1a executes the game program, thereby executing game processing regarding a predetermined game. For example, an external storage medium that stores the game program can be attached to the slot 23 of the information processing apparatus 1a, and the processor 81 of the information processing apparatus 1a can read the game program stored in the external storage medium into the DRAM 85 and execute the game program. The game program may be stored in the flash memory 84 of the information processing apparatus 1a, or may be stored in another storage device that can be read by the information processing apparatus 1a. The predetermined game may be any game such as a racing game, a card game, a table game, a sport game, a fighting game, a shooting game, a role-playing game, a music game, or the like.

On the other hand, in FIGS. 4 and 5, the information processing apparatuses 1b to 1d function as child apparatuses. Each of the information processing apparatuses 1b to 1d as the child apparatuses may not store the game program for executing the predetermined game and not be able to execute the game program. That is, an external storage medium that stores the game program is not attached to the slot 23 of the child apparatus, and the game program is not stored in the flash memory 84 of the child apparatus, either.

Each child apparatus may also store the game program, but any one of the plurality of information processing apparatuses 1 may function as a parent apparatus, the remaining information processing apparatuses 1 may function as child apparatuses, and only the parent apparatus may execute game processing.

A plurality of child apparatuses may include an apparatus that only functions as a child apparatus.

A parent apparatus and child apparatuses may be information processing apparatuses of same type (e.g., game apparatuses of the same type). A parent apparatus and child apparatuses may be information processing apparatuses of different types. A plurality of child apparatuses may include an information processing apparatus of the same type as a parent apparatus and an information processing apparatus of a different type from the parent apparatus.

As shown in FIG. 4, a parent apparatus and child apparatuses may directly communicate with each other through local communication (e.g., a communication method based on a unique protocol or a method compliant with the Wi-Fi standard). As shown in FIG. 5, a parent apparatus and child apparatuses may communicate with each other via the Internet 8. In the exemplary embodiment, a predetermined game is executed using a parent apparatus and child apparatuses. The parent apparatus and the child apparatuses establish connections with each other before the predetermined game starts.

Specifically, a parent apparatus acquires operation data relating to an operation on the controller (the first controller or the second controller) of the parent apparatus. Here, the operation data relating to an operation on the controller of the parent apparatus is referred to as “parent apparatus operation data”. A child apparatus transmits operation data relating to an operation on the controller (the first controller or the second controller) of the child apparatus to the parent apparatus. Here, the operation data transmitted from the child apparatus to the parent apparatus is referred to as “child apparatus operation data”.

The parent apparatus performs game processing based on the parent apparatus operation data. The parent apparatus also receives the child apparatus operation data transmitted from the child apparatus and performs game processing based on the child apparatus operation data. The content of the game processing differs depending on the type of the game.

Next, the parent apparatus generates image data based on the result of the game processing. Specifically, the parent apparatus generates parent apparatus image data and child apparatus image data.

The parent apparatus outputs the generated parent apparatus image data to the display 12 or the stationary monitor 5. Consequently, a parent apparatus game image is displayed on the display 12 or the stationary monitor 5 of the parent apparatus. The parent apparatus also transmits the generated child apparatus image data to the child apparatus. The child apparatus receives the child apparatus image data transmitted from the parent apparatus and outputs the child apparatus image data to the display 12 or the stationary monitor 5. Consequently, a child apparatus game image is displayed on the display 12 or the stationary monitor 5 of the child apparatus. The parent apparatus may generate parent apparatus sound data and output a sound based on the sound data. The parent apparatus may also generate child apparatus sound data and transmit the child apparatus sound data to the child apparatus, and the child apparatus may output a sound based on the child apparatus sound data.

As described above, the game system 10 for performing the game according to the exemplary embodiment includes a plurality of information processing apparatuses 1, any one of the plurality of information processing apparatuses 1 functions as a parent apparatus, and the other information processing apparatuses 1 function as child apparatuses. Game processing is performed based on parent apparatus operation data relating to an operation performed on the parent apparatus. Child apparatus operation data relating to an operation performed on each child apparatus is transmitted from the child apparatus to the parent apparatus, and game processing based on the child apparatus operation data is performed by the parent apparatus. The parent apparatus generates a game image relating to the result of the game processing and displays the game image on the display 12 or the stationary monitor 5 of the parent apparatus. The parent apparatus also transmits a game image relating to the result of the game processing to the child apparatus, and the game image is displayed by the child apparatus. Consequently, a game is performed in the game system 10 including the parent apparatus and the child apparatuses.

Next, a description is given of the game according to the exemplary embodiment performed using the game system 10 as described above.

As the game according to the exemplary embodiment, a first type of game and a second type of game are performed. First, the first type of game is described.

### (First Type of Game)

The first type of game is a multiplay game performed by a plurality of users and is a game performed by each user while viewing a game image displayed on a screen of an information processing apparatus 1 (the screen of the display 12 or the stationary monitor 5) of the user. For example, the first type of game is a competition table game performed by each user by avoiding viewing a game image displayed on a screen of an information processing apparatus 1 of another user.

The first type of game may be executed by the game system 10 formed by a plurality of information processing apparatuses 1 in which the mobile mode, the stationary mode, and the table mode coexist. The first type of game may also be executed by the game system 10 formed by a plurality of information processing apparatuses 1 that operate in any of the mobile mode, the stationary mode, and the table mode.

The first type of game can be executed through both the local communication and the Internet communication. The first type of game may be configured to be executed through only either one of the local communication and the Internet communication.

A description is given below of a case where a mahjong game is performed as the first type of game using the four information processing apparatuses 1 (1a to 1d) in the mobile mode shown in FIG. 4. For example, the mahjong game is performed by four users (user A to D). The information processing apparatus 1a as the parent apparatus is used by the user A, and the information processing apparatuses 1b to 1d as the child apparatuses are used by the users B to D, respectively. Hereinafter, the information processing apparatus 1a is occasionally referred to as the “parent apparatus 1a”, and the information processing apparatuses 1b to 1d are occasionally referred to as the “child apparatuses 1b to 1d”.

FIG. 6A is a diagram showing an example of a game image displayed on a display 12a of the information processing apparatus 1a in a case where the mahjong game is performed as the first type of game. FIG. 6B is a diagram showing an example of a game image displayed on a display 12b of the information processing apparatus 1b in a case where the mahjong game is performed as the first type of game. FIG. 6C is a diagram showing an example of a game image displayed on a display 12c of the information processing apparatus 1c in a case where the mahjong game is performed as the first type of game. FIG. 6D is a diagram showing an example of a game image displayed on a display 12d of the information processing apparatus 1d in a case where the mahjong game is performed as the first type of game.

On the display 12 of each information processing apparatuses 1, only tiles in hand of the user relating to the information processing apparatus 1 are displayed so that the tiles in hand can be recognized, and tiles in hand of the other users cannot be recognized. For example, as shown in FIG. 6A, on the display 12a, a game image including an image representing tiles in hand 70a of the user A and an image indicating a place (an image of a mahjong table) are displayed. In the game image displayed on the display 12a, tiles in hand 70b of the user B, tiles in hand 70c of the user C, and tiles in hand 70d of the user D cannot be recognized. For example, in the game image displayed on the display 12a, only upper surfaces or back surfaces of the tiles in hand 70b, the tiles in hand 70c, and the tiles in hand 70d may be displayed. Alternatively, on the display 12a, the tiles in hand 70b, the tiles in hand 70c, and the tiles in hand 70d may not be displayed at all.

Similarly, on the display 12b, only the tiles in hand 70b of the user B are displayed so that the tiles in hand 70b can be recognized (FIG. 6B). On the display 12c, only the tiles in hand 70c of the user C are displayed so that the tiles in hand 70c can be recognized (FIG. 6C). On the display 12d, only the tiles in hand 70d of the user D are displayed so that the tiles in hand 70d can be recognized (FIG. 6D).

If the turn of the user A of the parent apparatus 1a comes, the user A acquires a single tile and selects and discards any of the plurality of tiles in hand 70a including the acquired tile by operating the left controller 3 and/or the right controller 4. Similarly, if the turn of the user of each child apparatus comes, the user selects and discards any of the plurality of tiles in hand by operating the left controller 3 and/or the right controller 4 attached to the main body apparatus 2.

Specifically, the parent apparatus 1a manages the tiles in hand of each user, the order of the users, and a tile to be acquired by each user in the mahjong game. If the turn of the user A comes, the parent apparatus 1a acquires parent apparatus operation data relating to an operation on the left controller 3 and/or the right controller 4 and performs game processing based on the parent apparatus operation data (the process of acquiring a tile, the process of selecting a tile, the process of discarding the selected tile, and the like). The parent apparatus 1a displays a parent apparatus game image (FIG. 6A) relating to the result of the game processing on the display 12a of the parent apparatus 1a.

For example, if the turn of the user B comes, the child apparatus 1b acquires operation data relating to an operation on the left controller 3 and/or the right controller 4 and transmits the operation data as child apparatus operation data to the parent apparatus 1a. The parent apparatus 1a performs game processing based on the child apparatus operation data received from the child apparatus 1b, generates a child apparatus game image (FIG. 6B) relating to the result of the game processing, and transmits the game image to the child apparatus 1b. The child apparatus 1b displays the game image received from the parent apparatus 1a on the display 12b of the child apparatus 1b. Also if the turn of the user C or the user D comes, similar processes are performed by the child apparatus 1c or the child apparatus 1d and the parent apparatus 1a. If the turn of each user comes, display that urges an input may be performed on the screen of the information processing apparatus relating to the user, and display indicating waiting for an input may be performed on the screens of the information processing apparatuses relating to the other users.

If the parent apparatus 1a operates in the stationary mode or the table mode, the parent apparatus 1a acquires parent apparatus operation data relating to an operation on the first controller or the second controller wirelessly connected to the parent apparatus and performs game processing based on the parent apparatus operation data. If each child apparatus operates in the stationary mode or the table mode, the child apparatus transmits child apparatus operation data relating to an operation on the first controller or the second controller wirelessly connected to the child apparatus to the parent apparatus 1a.

An operation performed on each information processing apparatus (e.g., the operation of selecting any of a plurality of tiles in hand) may be performed using the touch panel 13. For example, the parent apparatus 1a may acquire parent apparatus operation data relating to a touch operation on the touch panel 13a provided on the display 12a and perform game processing based on the parent apparatus operation data. Similarly, each child apparatus may acquire touch operation data relating to a touch operation on the touch panel 13 and transmit the operation data as child apparatus operation data to the parent apparatus 1a, and the parent apparatus 1a may perform the above game processing based on the child apparatus operation data.

As the first type of game, a card game that uses playing cards or other cards or a competition table game such as a hanafuda game or the like may be performed. On the display 12 of each information processing apparatus 1, only the hand of each user (cards that the user has, cards in hand, tiles in hand, or the like) is displayed, and the hands of the other users are not displayed.

As the first type of game, not only the above game but also a game performed by each user using an item of the user may be performed. For example, a game where each user can view an item of the user, but cannot view items of the other users may be performed. A game where each user can view an item of the user and items of the other users may be performed.

As described above, each user may select an item configured to be selected by the user (e.g., a tile in hand, a card in hand, a card that the user has, or the like), and the game may progress based on the selected item.

In the game system 10 that uses the local communication or the Internet communication, not only the above competition table game but also another game may be performed.

For example, a game that progresses by a user object relating to each user being controlled in accordance with an operation of the user in a virtual space may be performed. As an example of such a game, a racing game, a shooting game, or the like may be performed. For example, in a virtual space, a user object PCa relating to the parent apparatus 1a and user objects PCb to PCd relating to the child apparatuses 1b to 1d are placed. The parent apparatus 1a controls the user object PCa based on parent apparatus operation data. The parent apparatus 1a also controls the user objects PCb to PCd based on child apparatus operation data received from the child apparatuses 1b to 1d, respectively. Virtual cameras VCa to VCd relating to the user object PCa to PCd are set in the virtual space, and the parent apparatus 1a generates game images Ga to Gd based on the virtual cameras VCa to VCd, respectively. The parent apparatus 1a displays the generated game image Ga on the display 12 or the stationary monitor 5 of the parent apparatus 1a and transmits the generated game images Gb to Gd to the child apparatuses 1b to 1d, respectively. The child apparatuses 1b to 1d display the game images Gb to Gd received from the parent apparatus 1a on the displays 12 or the stationary monitors 5 of the child apparatuses 1b to 1d, respectively.

### (Second Type of Game)

Next, the second type of game is described. The second type of game is a multiplay game performed in the game system 10 configured by the local communication. For example, the second type of game is performed using a plurality of information processing apparatus 1 in the table mode. That is, basically, the second type of game is performed using a plurality of main body apparatuses 2 in the state where the left controllers 3 and the right controllers 4 are detached. Alternatively, second controllers 7 may be wirelessly connected to main body apparatuses 2 in the state where the left controllers 3 and the right controllers 4 are attached to the main body apparatuses 2 or the state where the left controllers 3 and the right controllers 4 are detached from the main body apparatuses 2, and the second type of game may be performed based on operations on the second controllers 7. A description is given below of a case where the second type of game is performed using a plurality of main body apparatuses 2 from which the left controllers 3 and the right controllers 4 are detached.

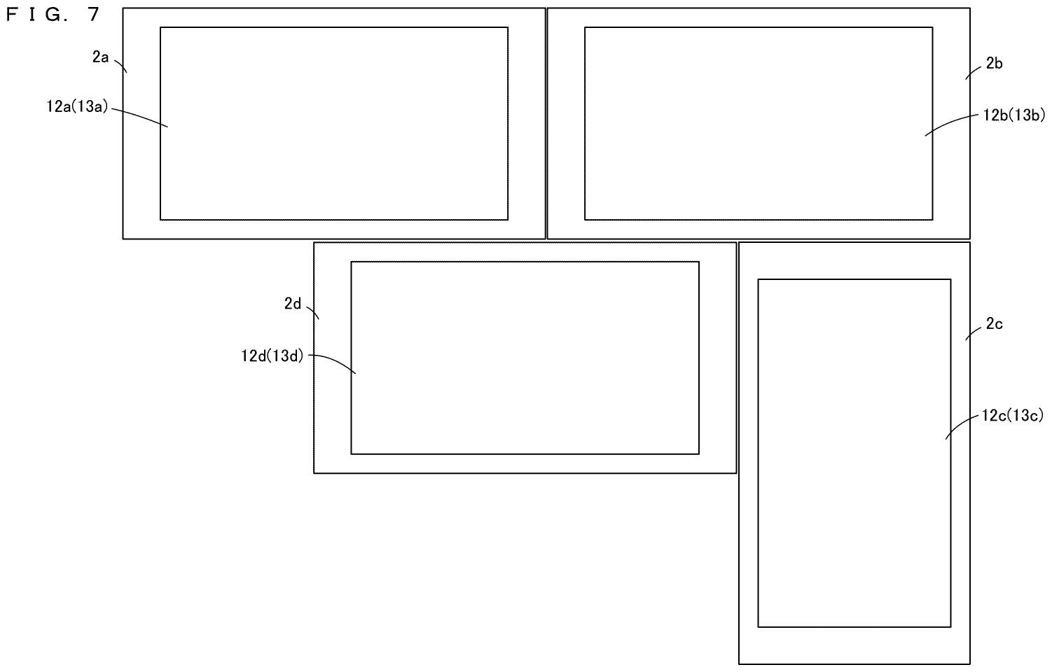

Specifically, in the second type of game, for example, a plurality of main body apparatuses 2 are placed next to each other on a table so that the screens of the displays 12 face up. FIG. 7 is a diagram showing an example of the placement of four main body apparatuses 2a to 2d in a case where the second type of game is performed.

As shown in FIG. 7, for example, the main body apparatus 2a and the main body apparatus 2b are placed on a table so that a right side surface of the main body apparatus 2a and a left side surface of the main body apparatus 2b are close to each other. The main body apparatuses 2a to 2d are placed so that an upper surface of the main body apparatus 2d is close to lower surfaces of the main body apparatus 2a and the main body apparatus 2b, a left side surface of the main body apparatus 2c is close to the lower surface of the main body apparatus 2b, a lower surface of the main body apparatus 2c is close to a right side surface of the main body apparatus 2d.

The main body apparatus 2a functions as a parent apparatus, and the main body apparatuses 2b to 2d function as child apparatuses. First, the main body apparatus 2a as the parent apparatus performs a positional relationship identification process for identifying the positional relationships between the main body apparatuses. For example, a user performs a touch operation on the touch panels 13 of the main body apparatuses 2 placed as shown in FIG. 7. Specifically, the user touches any position on the touch panel 13 of a certain main body apparatus 2, for example, with their finger and moves the finger to any position on the touch panel 13 of another main body apparatus 2 by sliding the finger in the touch state.

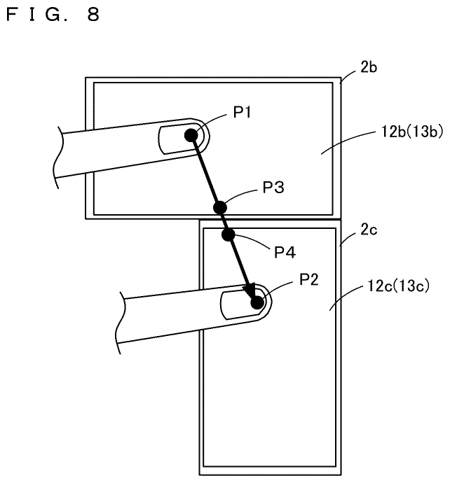

FIG. 8 is a diagram showing an overview of the positional relationship identification process. The parent apparatus performs display that urges the user to perform a slide operation across a plurality of main body apparatuses. In accordance with this display, the user starts a touch from a position P1 on a touch panel 13b of the main body apparatus 2b, for example, using their finger and moves the finger to a position P3 on the periphery of the touch panel 13b by linearly sliding the finger in the direction of an arrow in FIG. 8 in the touch state. Further, the user moves the finger to a position P4 on the periphery of a touch panel 13c by sliding the finger by passing between the touch panel 13b and the touch panel 13c, and moves the finger to a position P2 on the touch panel 13c by further sliding the finger.

If such a serial slide operation across the touch panel 13b and the touch panel 13c is performed, the main body apparatuses 2b and 2c detect a plurality of touch positions. The main body apparatuses 2b and 2c transmit touch position data indicating the detected touch positions to the main body apparatus 2a as the parent apparatus. Based on the touch position data received from the main body apparatuses 2b and 2c, the parent apparatus can identify the state where the main body apparatuses 2b and 2c are placed in a positional relationship as shown in FIG. 8. For example, based on the touch position data from the main body apparatus 2b, the parent apparatus calculates a vector from the touch position P1 to the touch position P3 on the touch panel 13b. Based on the touch position data from the main body apparatus 2c, the parent apparatus calculates a vector from the touch position P4 to the touch position P2 on the touch panel 13c. Based on the two calculated vectors, the parent apparatus can identify the proximity between the main body apparatuses 2b and 2c in a positional relationship where the two calculated vectors are connected together. The parent apparatus may also calculate the difference time between the time where the main body apparatus 2b ceases to detect the touch position P3 (the time when the finger separates from the position P3) and the time when the main body apparatus 2c detects the touch position P4. Based on the calculated difference time and the velocity of the slide operation of the user calculated from the touch position data, the parent apparatus can identify the distance between the main body apparatus 2b and the main body apparatus 2c. The user performs such a slide operation on the main body apparatuses 2. Consequently, the parent apparatus can identify the positional relationships between the main body apparatuses 2.

If the main body apparatuses 2a to 2d are placed in positional relationships as shown in FIG. 7, a single large screen is formed by the displays 12a to 12d of the main body apparatuses 2. Different images are displayed on the displays 12a to 12d of the main body apparatuses 2, and a single large image is displayed based on the images displayed on the displays 12a to 12d. The second type of game is performed using the displays 12 of such a plurality of main body apparatuses 2.

For example, a racing game is performed as the second type of game. In this case, a single course is displayed on the displays 12a to 12d, and the racing game is performed on this course. A description is given below of a case where the racing game is performed as the second type of game by four users A to D.

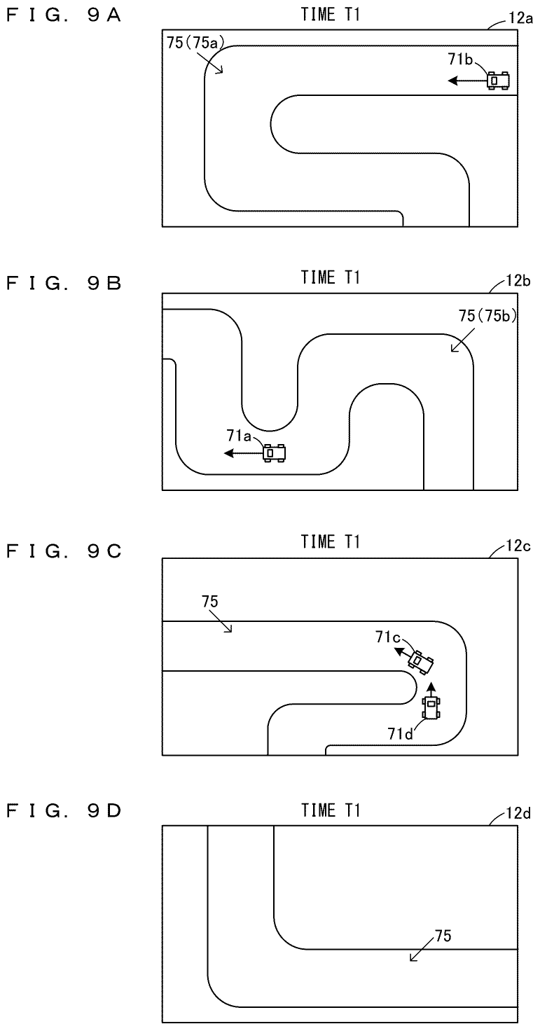

FIG. 9A is a diagram showing an example of a game image displayed on the display 12a of the main body apparatus 2a at a time T1 during the execution of the second type of game. FIG. 9B is a diagram showing an example of a game image displayed on the display 12b of the main body apparatus 2b at the time T1. FIG. 9C is a diagram showing an example of a game image displayed on the display 12c of the main body apparatus 2c at the time T1. FIG. 9D is a diagram showing an example of a game image displayed on the display 12d of the main body apparatus 2d at the time T1.

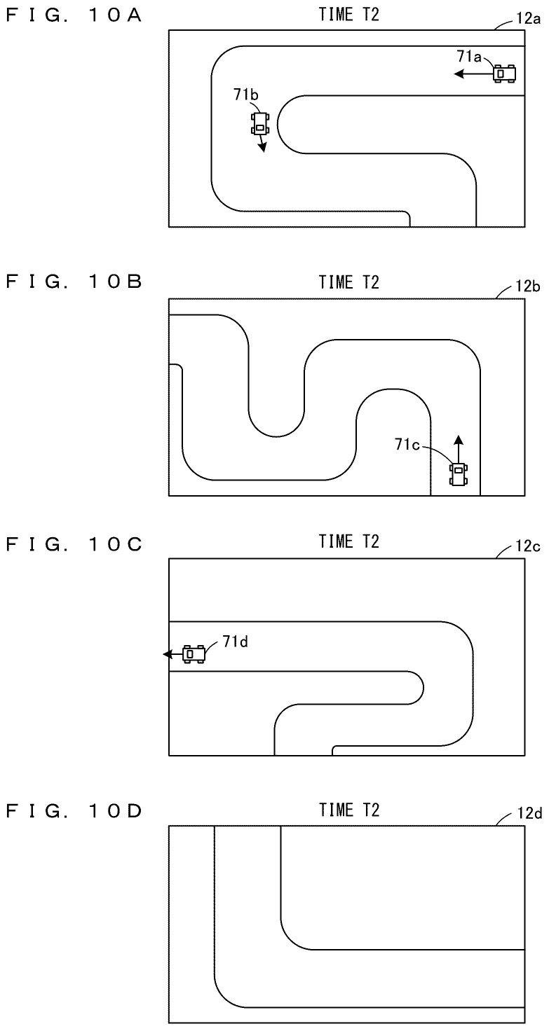

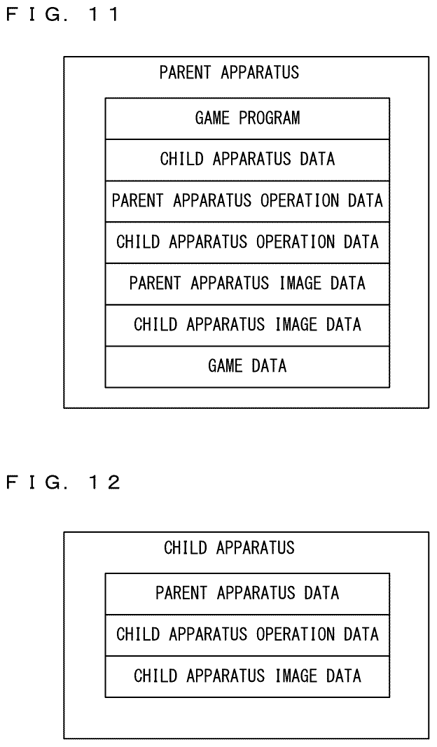

FIGS. 10A to 10D are diagrams showing examples of games images displayed on the displays 12a to 12d at a time T2 after the lapse of a predetermined time from the time T1.

As shown in FIGS. 9A to 9D, on the displays 12a to 12d, parts (portions 75a to 75d) of a course 75 are displayed, and different images are displayed. If the displays 12a to 12d are placed in the positional relationships shown in FIG. 7, a single course 75 composed of the portions 75a to 75d is formed. On the course 75, cart objects 71a to 71d are placed.

The user A causes the cart object 71a to run the course 75 in the direction of an arrow in FIG. 10A using a controller (a first controller or a second controller) CTLa wirelessly connected to the main body apparatus 2a as the parent apparatus. Similarly, the user B causes the cart object 71b to run the course 75 using a controller CTLb wirelessly connected to the main body apparatus 2b as one of the child apparatuses. Similarly, the user C causes the cart object 71c to run the course 75 using a controller CTLc wirelessly connected to the main body apparatus 2c as one of the child apparatuses. The user D also causes the cart object 71d to run the course 75 using a controller CTLd wirelessly connected to the main body apparatus 2d as one of the child apparatuses.

The main body apparatus 2a as the parent apparatus generates game images to be displayed on the displays 12a to 12d based on the positional relationships identified in the positional relationship identification process. Specifically, before a race starts, the parent apparatus defines a single course 75 in a virtual space, divides the course 75 into the portions 75a to 75d based on the identified positional relationships between the main body apparatuses, and sets virtual cameras relating to the portions. The parent apparatus performs game processing based on operation data from each of the main body apparatuses 2 and generates game images relating to the portions 75a to 75d.

More specifically, the parent apparatus stores the positions in the virtual space of the cart objects 71a to 71d. The parent apparatus updates the position of the cart object 71a based on parent apparatus operation data relating to an operation on the controller CTLa. The main body apparatus 2b as one of the child apparatuses transmits child apparatus operation data relating to an operation on the controller CTLb to the parent apparatus. Similarly, the main body apparatuses 2c and 2d as some of the child apparatuses also transmit child apparatus operation data relating to operations on the controllers CTLc and CTLd connected to the main body apparatuses 2c and 2d, respectively, to the parent apparatus. The parent apparatus updates the positions of the cart objects 71b to 71d based on the child apparatus operation data transmitted from each of the main body apparatuses 2b to 2d, respectively. Then, the parent apparatus generates a game image based on the virtual camera relating to the portion 75a of the course 75 and displays the generated game image on the display 12a. The parent apparatus also generates game images based on the virtual cameras relating to the portions 75b to 75d of the course 75 and transmits the generated game images to the main body apparatuses 2b to 2d, respectively. The main body apparatuses 2b to 2d display the received game images on the displays 12b to 12d, respectively.

As shown in FIGS. 10A to 10D, the cart objects 71 have moved from the positions shown in FIGS. 9A to 9D. For example, the cart object 71b has moved in the left direction from the position of the right end of the display 12a (see FIG. 9A) and moved to a position in the left direction on the display 12a (see FIG. 10A). At the time T1, as shown in FIG. 9B, the cart object 71a is displayed on the display 12b. At the time T2, as shown in FIG. 10A, the cart object 71a is displayed on the display 12a close to the left side of the display 12b.

As described above, in the second type of game according to the exemplary embodiment, game images of different portions in a common virtual space are displayed on the displays 12 of a plurality of main body apparatuses 2. A parent apparatus performs the process of identifying the positional relationships between the main body apparatuses, game processing, and the process of generating game images, and transmits the game images to child apparatuses, whereby it is possible to perform a game based on the positional relationships between the plurality of main body apparatuses 2.

The positional relationships between the main body apparatuses 2a to 2d are not limited to those shown in FIG. 7. For example, the main body apparatuses may be placed not close to each other, but somewhat away from each other.

Although in the above description, the second type of game is performed based on an operation on the controller (the first controller or the second controller) wirelessly connected to a main body apparatus 2, the second type of game may be performed based on operations on the left controller 3 and the right controller 4 attached to a main body apparatus 2.

Although in the above description, a case has been exemplified where a racing game is performed as the second type of game, the second type of game may be another game. For example, the second type of game may be a bowling game. The game may be performed such that a single lane is formed by the displays 12 of a plurality of main body apparatuses 2, and a ball moves on a lane. The second type of game may also be a soccer game, a baseball game, or the like. The second type of game may be performed on a single field formed by the displays 12 of a plurality of main body apparatuses 2.

The second type of game may also be a puzzle game that uses the displays 12 of a plurality of main body apparatuses 2. For example, on the displays 12 of the main body apparatuses 2, partial images of a predetermined object are displayed. A user places the main body apparatuses 2 to form the predetermined object by connecting the partial images. In a case where such a puzzle game is performed, after the user places the main body apparatuses 2, the positional relationship identification process is performed, and it is determined whether or not the main body apparatuses 2 are placed in positional relationships in which the predetermined object is formed. The positional relationship identification process may be a process based on a slide operation of the user as described above, or may be a process using the sensing of proximity by a proximity sensing section.

Although in the above description, the second type of game is a multiplay game that uses a plurality of main body apparatuses 2, the second type of game may be a single-play game that uses a plurality of main body apparatuses 2. For example, a racing game may be performed by forming a single course by arranging a plurality of main body apparatuses 2 next to each other as shown in FIG. 7 and by a single user causing a cart object to run this course.

Also in a case where each information processing apparatus 1 executes the game program, the information processing apparatus 1 performs communication (the local communication or the Internet communication), whereby the above game may be able to be performed between a plurality of information processing apparatuses. In this case, each information processing apparatus 1 executes the game program stored in the information processing apparatus 1 and performs game processing. The information processing apparatus 1 acquires operation data of the information processing apparatus 1 and also receives operation data from the other information processing apparatuses. The information processing apparatus 1 performs game processing based on the operation data of the information processing apparatus 1 and the operation data of the other information processing apparatuses 1 and displays a game image relating to the result of the game processing on the display 12 or the stationary monitor 5. As described above, a game performed in a case where each information processing apparatus 1 executes the game program and a game performed in a case where only a parent apparatus executes the game program as described above may be exactly the same game. The game performed in a case where each information processing apparatus 1 executes the game program and the game performed in a case where only a parent apparatus executes the game program may have different functions. For example, functions may be more limited in the second game than in the first game. For example, the resolution of a game image of the game performed in a case where only a parent apparatus executes the game program may be lower than that of a game image of the game performed in a case where each information processing apparatus 1 executes the game program.

### (Details of Processes of Parent Apparatus and Child Apparatus)

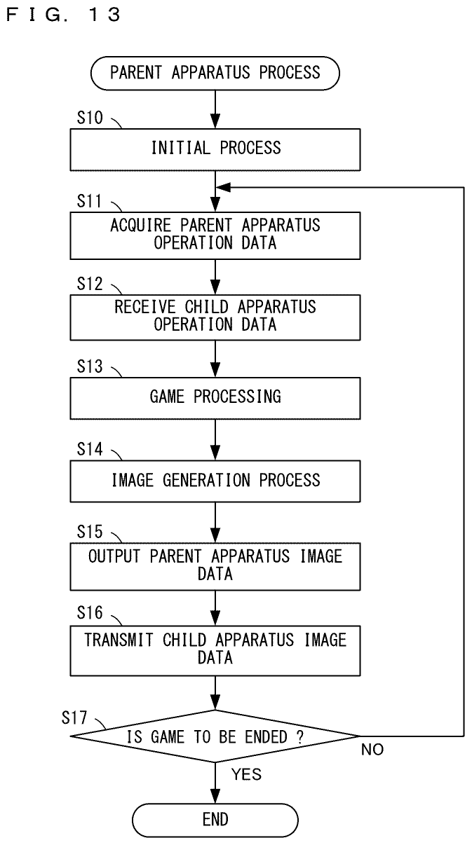

Next, the details of processes performed by a parent apparatus and a child apparatus are described. First, data stored in the parent apparatus and the child apparatus is described. FIG. 11 is a diagram showing an example of the data stored in the parent apparatus. FIG. 12 is a diagram showing an example of the data stored in the child apparatus. The data shown in FIGS. 11 and 12 is stored in a memory (any of an external storage medium, the flash memory 84, and the DRAM 85) of each main body apparatus 2.

As shown in FIG. 11, the parent apparatus stores a game program, child apparatus data, parent apparatus operation data, child apparatus operation data, parent apparatus image data, child apparatus image data, and game data.

The game program is a program for executing a predetermined game (e.g., the above first type of game and the above second type of game) and is a program for executing game processing described below.

The child apparatus data is data regarding a child apparatus connected to the parent apparatus. For example, the child apparatus data includes information (e.g., an apparatus ID, a MAC address, or the like) that identifies the child apparatus. The child apparatus data is stored with respect to each child apparatus connected to the parent apparatus.

The parent apparatus operation data is data relating to an operation performed on the controller (the first controller or the second controller) of the parent apparatus. The main body apparatus 2 acquires the parent apparatus operation data from the controller of the parent apparatus at predetermined time intervals (e.g., 1/200-second intervals). The parent apparatus operation data may include data relating to a touch operation on the touch panel 13 of the main body apparatus 2.

The child apparatus operation data is data relating to an operation performed on the controller (the first controller or the second controller) of the child apparatus and is transmitted from the child apparatus. The child apparatus operation data may include data relating to a touch operation on the touch panel 13 of the main body apparatus 2. The child apparatus transmits the child apparatus operation data to the parent apparatus at predetermined time intervals (e.g., 1/60-second intervals). In a case where a plurality of child apparatuses are connected to the parent apparatus, the child apparatus operation data received from each of the child apparatuses is stored.

The parent apparatus image data is image data indicating a game image displayed on the screen of the parent apparatus (the screen of the display 12 or the stationary monitor 5) and is generated by the parent apparatus.

The child apparatus image data is image data indicating a game image displayed on the screen of the child apparatus (the screen of the display 12 or the stationary monitor 5) and is data generated by the parent apparatus and transmitted to the child apparatus. In a case where a plurality of child apparatuses are connected to the parent apparatus, the child apparatus image data of each of the plurality of child apparatuses is generated and stored. The image size (the resolution) of the child apparatus image data may be variable. For example, the image size of the child apparatus image data may change in accordance with the number of child apparatuses connected to the parent apparatus. The image size of the parent apparatus image data and the image size of the child apparatus image data may be different from each other.

The game data is data used in the game. For example, in a case where the above mahjong game is performed as the first type of game, data indicating tiles in hand of each user, data regarding a tile to be acquired by each user, data regarding the order of the users, data regarding the score of each user, and the like are stored as the game data.

In a case where the above racing game is performed as the second type of game, data indicating the positional relationships between the main body apparatuses 2, data indicating the course 75, data indicating the portions 75a to 75d of the course 75, data regarding the virtual cameras relating to the portions, and the like are stored as the game data. As the game data, data indicating the positions, the directions, the velocities, and the like of the cart objects 71a to 71d and data indicating the shapes, the external appearance, and the like of the cart objects 71a to 71d are stored.

On the other hand, as shown in FIG. 12, the child apparatus stores parent apparatus data, child apparatus operation data, and child apparatus image data.

The parent apparatus data is data regarding a parent apparatus connected to the child apparatus. For example, the parent apparatus data includes information (e.g., an apparatus ID, a MAC address, or the like) that identifies the parent apparatus.

The child apparatus operation data is data relating to an operation performed on the controller (the first controller or the second controller) of the child apparatus. The main body apparatus 2 acquires the child apparatus operation data from the controller of the child apparatus at predetermined time intervals (e.g., 1/200-second intervals). The child apparatus operation data may include data relating to a touch operation on the touch panel 13 of the main body apparatus 2. The child apparatus transmits the acquired child apparatus operation data to the parent apparatus at predetermined time intervals (e.g., 1/60-second intervals).

The child apparatus image data is image data indicating a game image displayed on the screen of the child apparatus (the screen of the display 12 or the stationary monitor 5) and is data received from the parent apparatus.

The child apparatus does not store the above game program, but stores a program for participating in the game performed by the parent apparatus (a program for connecting to the parent apparatus, a program for making a participation request to the parent apparatus, or the like).

Next, the processes performed by the parent apparatus and the child apparatus are described. The following description is given on the assumption that a parent apparatus and child apparatuses are connected together in the communication form shown in FIG. 4. A parent apparatus and child apparatuses may be connected together in the communication form shown in FIG. 5.

### (Parent Apparatus Process)

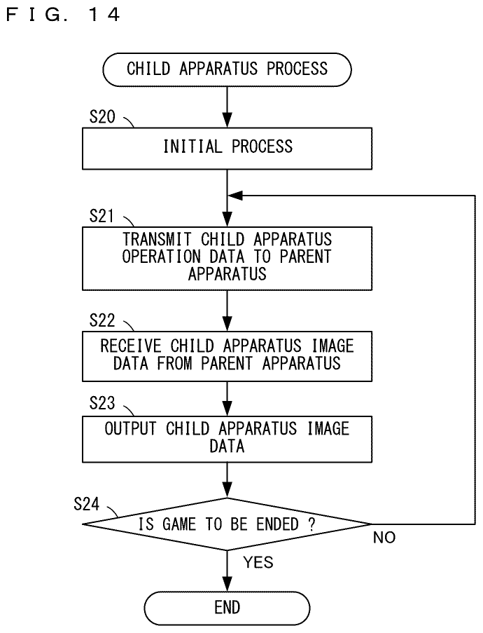

FIG. 13 is a flow chart showing an example of a parent apparatus process performed by the parent apparatus when a predetermined game is performed in the game system 10. The process shown in FIG. 13 is performed by the processor 81 of the main body apparatus 2 as the parent apparatus.

As shown in FIG. 13, first, the parent apparatus performs an initial process (step S10). In the initial process, based on an operation of a user, the process of determining a game to be executed, the process of selecting a communication form (the local communication or the Internet communication), the process of setting an information processing apparatus 1 as the parent apparatus, the process of connecting the parent apparatus and a child apparatus, a process for inviting a user (a child apparatus) to participate in the game, a process for causing a child apparatus that makes a participation request to participate in the game, and the like are performed. A communication form configured to be selected by the user differs in accordance with the game to be executed. In a case where the second type of game is performed, in the initial process, the positional relationship identification process for identifying the positional relationships between main body apparatuses 2 is performed. If the initial process ends, the parent apparatus starts the game, and from this point onward, repeatedly executes the processes of steps S11 to S17 at predetermined time intervals (e.g., 1/60-second intervals).

After the process of step S10, the parent apparatus acquires parent apparatus operation data (step S11). Specifically, if the parent apparatus operates in the mobile mode, the parent apparatus acquires parent apparatus operation data from the first controller (the left controller 3 and the right controller 4) attached to the parent apparatus. If the parent apparatus operates in the stationary mode or the table mode, the parent apparatus acquires parent apparatus operation data from the first controller or the second controller wirelessly connected to the parent apparatus. The parent apparatus may acquire data relating to a touch operation on the touch panel 13 of the main body apparatus 2 as parent apparatus operation data.

Next, the parent apparatus receives child apparatus operation data from child apparatuses (step S12). Specifically, the network communication section 82 of the parent apparatus receives child apparatus operation data transmitted from each child apparatus. The timings when the parent apparatus receive the child apparatus operation data from the child apparatuses may be different from each other.

Next, the parent apparatus performs game processing based on the parent apparatus operation data (step S13). In step S13, the parent apparatus also performs game processing based on the received child apparatus operation data.

For example, in a case where the above mahjong game is performed as the first type of game, in the turn of the user A, the parent apparatus performs the process of adding a single tile to the tiles in hand 70a owned by the user A, and based on the parent apparatus operation data, also selecting any one of the plurality of tiles in hand 70a and discarding the selected tile. In the turn of the user B, the parent apparatus performs the process of adding a single tile to the tiles in hand 70b owned by the user B, and based on the child apparatus operation data from the child apparatus 1b, also selecting any one of the plurality of tiles in hand 70b and discarding the selected tile. The parent apparatus also performs similar processes based on the child apparatus operation data from the child apparatus 1c and the child apparatus operation data from the child apparatus 1d. The parent apparatus calculates the score of each user in the game processing.

In a case where the above racing game is performed as the second type of game, the parent apparatus moves the cart object 71a in the virtual space and updates the position of the cart object 71a based on the parent apparatus operation data. The parent apparatus moves the cart objects 71b to 71d in the virtual space and updates the positions of the cart objects 71b to 71d, respectively, based on the child apparatus operation data from the child apparatuses.

Next, the parent apparatus performs an image generation process based on the result of the game processing (step S14). Specifically, in the image generation process, the parent apparatus generates parent apparatus image data and child apparatus image data. The parent apparatus may also generate parent apparatus sound data and child apparatus sound data.

For example, in a case where the above mahjong game is performed as the first type of game, the parent apparatus generates a game image including the tiles in hand 70a of the user A (FIG. 6A) as parent apparatus image data. The parent apparatus also generates a game image including the tiles in hand 70b of the user B (FIG. 6B), a game image including the tiles in hand 70c of the user C (FIG. 6C), and a game image including the tiles in hand 70d of the user D (FIG. 6D) as child apparatus image data.

In a case where the above racing game is performed as the second type of game, the parent apparatus generates a parent apparatus game image (e.g., FIG. 9A) as parent apparatus image data based on the virtual camera relating to the portion 75a of the course 75. The parent apparatus generates child apparatus game images (e.g., FIGS. 9B to 9D) as child apparatus image data based on the virtual cameras relating to the portions 75b to 75d of the course 75.

Next, the parent apparatus outputs the parent apparatus image data generated in step S14 to the display 12 or the stationary monitor 5 (step S15). The parent apparatus also outputs a sound based on the parent apparatus sound data generated in step S14 from the speakers 88 or the speaker of the stationary monitor 5.

Next, the parent apparatus transmits the child apparatus image data generated in step S14 to the child apparatuses (step S16). Specifically, the network communication section 82 of the parent apparatus transmits the generated child apparatus image data to the child apparatuses. The network communication section 82 of the parent apparatus also transmits the generated sound data to the child apparatuses.

Next, the parent apparatus determines whether or not to end the game (step S17). For example, if the game is completed, or if the user of the parent apparatus gives an instruction to force termination of the game during the game, or if child apparatus operation data regarding forced termination of the game is received from any of the child apparatuses during the game, the determination of the parent apparatus is YES in step S17. If the determination is YES in step S17, the parent apparatus ends the game and transmits a game end notification to the child apparatuses. If the determination is NO in step S17, the parent apparatus executes the process of step S11 again. The description of the parent apparatus process ends.

While the processes of steps S11 to S17 are repeatedly executed, i.e., while a predetermined game is performed between the parent apparatus and the child apparatuses, a new child apparatus may participate.

### (Child Apparatus Process)

FIG. 14 is a flow chart showing an example of a child apparatus process performed by the child apparatus.

As shown in FIG. 14, first, the child apparatus performs an initial process (step S20). In the initial process, based on an operation of a user, the process of setting an information processing apparatus 1 as the child apparatus, the process of selecting a parent apparatus to which to connect, a process for transmitting a participation request to participate in a game performed by the parent apparatus, and the like are performed. If the game is started by the parent apparatus, the child apparatus ends the initial process. From this point onward, the child apparatus repeatedly executes the processes of steps S21 to S24 at predetermined time intervals (e.g., 1/60-second intervals).

If the game is started, the child apparatus transmits child apparatus operation data to the parent apparatus (step S21). Specifically, if the child apparatus operates in the mobile mode, the child apparatus acquires operation data output from the first controller (the left controller 3 and the right controller 4) attached to the child apparatus. If the child apparatus operates in the stationary mode or the table mode, the child apparatus acquires operation data output from the first controller or the second controller connected to the child apparatus. The child apparatus may acquire data relating to a touch operation on the touch panel 13 of the main body apparatus 2 as operation data. Then, the network communication section 82 of the child apparatus transmits the acquired operation data as child apparatus operation data to the parent apparatus. Operation data output from the controller of the child apparatus may be transmitted as child apparatus operation data to the parent apparatus, or data obtained by performing a predetermined process on operation data output from the controller of the child apparatus may be transmitted as child apparatus operation data to the parent apparatus.

Next, the child apparatus receives child apparatus image data from the parent apparatus (step S22). The child apparatus may also receive child apparatus sound data from the parent apparatus.

The frequency of transmission of the child apparatus operation data from the child apparatus and the frequency of reception (the frame rate) of the child apparatus image data by the child apparatus may be different from each other. For example, the frequency of reception of the child apparatus image data may be lower than the frequency of transmission of the child apparatus operation data. For example, in accordance with the number of child apparatuses connected to the parent apparatus, the frequencies of reception of the child apparatus image data by the child apparatuses may be lowered. In this case, the frequencies of transmission of the child apparatus operation data from the child apparatuses may be the same as each other, regardless of the number of child apparatuses connected to the parent apparatus.

Next, the child apparatus outputs the received child apparatus image data (step S23). Specifically, if the child apparatus operates in the mobile mode or the table mode, the child apparatus outputs the received child apparatus image data to the display 12. If the child apparatus operates in the stationary mode, the child apparatus outputs the received child apparatus image data to the stationary monitor 5. The child apparatus may also output a sound based on the received sound data.

Next, the child apparatus determines whether or not to end the game (step S24). For example, if the child apparatus receives a game end notification from the parent apparatus, or if an instruction to force termination of the game is given in the child apparatus during the game, the child apparatus ends the game. If the game is not to be ended, the child apparatus executes the process of step S21 again. The description of the child apparatus process ends.

The processes of the above flow charts are merely examples, and for example, the order of steps may be switched, another step may be added, or some of the above steps may be omitted.

As described above, an information processing apparatus according to the exemplary embodiment operates in a mobile mode, a stationary mode, and a table mode as a plurality of play forms. In the mobile mode, the information processing apparatus performs a process relating to an operation on an operation device included in the information processing apparatus (e.g., the left controller 3 and the right controller 4 attached to the main body apparatus or the touch panel 13) and outputs an image relating to the result of the process to a display device (e.g., the display 12) included in the information processing apparatus. In the stationary mode, the information processing apparatus performs a process relating to an operation on an operation device externally connected to the information processing apparatus (e.g., the first controller or the second controller wirelessly connected to the main body apparatus) and outputs an image relating to the result of the process to a display device (e.g., the stationary monitor 5) externally connected to the information processing apparatus. In the table mode, the information processing apparatus performs a process relating to an operation on the operation device externally connected to the information processing apparatus (e.g., the first controller or the second controller wirelessly connected to the main body apparatus) and outputs an image relating to the result of the process to the display device (e.g., the display 12) included in the information processing apparatus. The information processing apparatus can also communicate with another information processing apparatus in a plurality of communication forms including Internet communication and wireless local communication.

In a game system including such a plurality of information processing apparatuses, any one of the plurality of information processing apparatuses functions as a parent apparatus, and the plurality of other apparatuses function as child apparatuses. The game system including the parent apparatus and the plurality of child apparatuses executes a multiplay game in a predetermined play form among the above plurality of play forms. The parent apparatus communicates with each of the child apparatuses in a communication form set for the game among the plurality of communication forms. The parent apparatus acquires first operation data (parent apparatus operation data) based on an input to the operation device relating to the predetermined play form, acquires second operation data (child apparatus operation data) received from each of the child apparatuses, and performs game processing regarding the game based on the first operation data and the second operation data. The parent apparatus generates a first image based on the game processing and a plurality of second images different from the first image. The parent apparatus outputs the first image to the display device relating to the predetermined play form and transmits the second images to the child apparatuses. Each of the child apparatuses communicates with the parent apparatus, transmits second operation data based on an input to the operation device relating to the predetermined play form to the parent apparatus, and outputs the second image received from the parent apparatus to the display device relating to the predetermined play form. Consequently, for example, even if a child apparatus does not store a game program and cannot execute the game program, a game can be performed between a parent apparatus and the child apparatus.

An example of the game performed in the game system is a game that progresses by players of the parent apparatus and the child apparatuses selecting selectable items (e.g., the first type of game such as the mahjong game or the like). Specifically, based on the first operation data, the parent apparatus selects an item configured to be selected by a player of the parent apparatus, and based on the second operation data of each of the child apparatuses, selects an item configured to be selected by a player of the child apparatus, and causes the game to progress based on each of the selected items. The parent apparatus generates as the first image an image that includes an image representing the item configured to be selected by the player of the parent apparatus (e.g., an image of the tiles in hand 70a), and does not include images representing the items configured to be selected by the other players (e.g., images of the tiles in hand 70b to 70d). The parent apparatus also generates, as the second images, images that include images representing the items configured to be selected by the players of the child apparatuses (e.g., an image of the tiles in hand 70b), and do not include images representing the items configured to be selected by the other players (e.g., images of the tiles in hand 70a, 70c, and 70d).

An example of the game performed in the game system is a game where the information processing apparatus operates in the mobile mode or the table mode and which is performed through the wireless local communication (e.g., the above second type of game). In this game, the parent apparatus generates images based on virtual cameras different from each other in a common virtual space as the first image and the second images. For example, a plurality of information processing apparatuses are placed in certain positional relationships, and a parent apparatus performs a positional relationship identification process for identifying the positional relationships between the plurality of information processing apparatuses. The parent apparatus generates the first image and the second images (e.g., FIGS. 9A to 9D) based on virtual cameras placed in accordance with the identified positional relationships.

In the above game system, the parent apparatus and the plurality of child apparatuses can operate in any of the above mobile mode, the above stationary mode, and the above table mode, and the plurality of child apparatuses may be apparatuses of the same type as the parent apparatus, or may be apparatuses of a different type from the parent apparatus. The plurality of child apparatuses may be apparatuses of different types. Although each of the parent apparatus and the plurality of child apparatuses has a configuration in which the left controller 3 and the right controller 4 are attachable to and detachable from the main body apparatus 2, at least any of the parent apparatus and the plurality of child apparatuses may be an apparatus in which the left controller 3 and the right controller 4 are fixed to the main body apparatus 2 so that the left controller 3 and the right controller 4 cannot be detached from the main body apparatus 2. In this case, a configuration may be employed in which the above first controller or the above second controller can be wirelessly connected to the apparatus, the stationary monitor 5 can be connected to the apparatus, and the apparatus can also operate in the above mobile mode, the above stationary mode, and the above table mode.

In the above exemplary embodiment, the positional relationships between main body apparatuses are identified by performing a touch operation on the touch panel 13 provided in each main body apparatus 2. In another exemplary embodiment, the method for identifying the positional relationships is not limited to the above, and may be another method. For example, the information processing apparatuses may include proximity sensing sections that detect that the information processing apparatuses are in proximity to each other, and based on the detection results of the proximity sensing sections, may identify the positional relationships between the information processing apparatuses. For example, the proximity sensing sections may sense the proximity between the information processing apparatuses using short-range communication (e.g., Near field communication: NFC). The proximity sensing sections may also sense the proximity between the main body apparatuses 2 using ultra-wideband wireless communication (Ultra Wide Band: UWB). The proximity sensing sections may sense the proximity between the main body apparatuses 2 using other sensors.

In accordance with the sensing of the proximity between information processing apparatuses by proximity sensing sections, the transmission of second images to the information processing apparatuses that are in proximity to each other may be started. For example, a case is assumed where the above game is executed in a game system including a parent apparatus, a first child apparatus, and a second child apparatus. In this case, when the parent apparatus displays a first image on the display device of the parent apparatus and also repeatedly transmits second images to the first child apparatus and the second child apparatus, and if a third child apparatus comes close to any of the parent apparatus, the first child apparatus, and the second child apparatus, the parent apparatus may identify the positional relationship with the third child apparatus and start the transmission of a second image to the third child apparatus. The parent apparatus may generate the first image and the second images based on virtual cameras placed in accordance with the positional relationships between the information processing apparatuses.

In the above exemplary embodiment, a parent apparatus provides a game to a child apparatus. In another exemplary embodiment, a parent apparatus may provide not only a game but also any application to a child apparatus.

While the exemplary embodiment has been described, the above description is merely illustrative, and the exemplary embodiment may be improved and modified in various manners.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. A game system including a plurality of information processing apparatuses including a parent apparatus and a plurality of child apparatuses,
each of the plurality of information processing apparatuses comprising:
one or more processors; and
one or more non-transitory computer-readable media having stored therein instructions that, when executed, cause the one or more processors to execute information processing comprising:
among a plurality of play forms,
in a first play form, performing a process relating to an operation input to an operation device included in the information processing apparatus and outputting an image to a display device included in the information processing apparatus,
in a second play form, performing a process relating to an operation input to an operation device externally connected to the information processing apparatus and outputting an image to a display device externally connected to the information processing apparatus, and
in a third play form, performing a process relating to an operation input to the operation device externally connected to the information processing apparatus and outputting an image to the display device included in the information processing apparatus; and
communicating with another information processing apparatus in a plurality of communication forms including transmission and reception via the Internet and in a wireless manner,
the game processing in the parent apparatus among the plurality of information processing apparatuses further comprising:
regarding a multiplay game in a predetermined play form among the plurality of play forms,
performing the communication with each of the child apparatuses in the communication form set for the game among the plurality of communication forms;
acquiring first operation data based on an input to the operation device relating to the play form;
acquiring second operation data received from each of the child apparatuses;
performing game processing regarding the game based on the first operation data and the second operation data;
generating a first image and a plurality of second images different from the first image based on the game processing;
outputting the first image to the display device relating to the play form; and
transmitting the second images to the child apparatuses, and
the game processing in each of the child apparatuses further comprising:
performing the communication with the parent apparatus;
transmitting the second operation data based on an input to the operation device relating to the play form to the parent apparatus; and
outputting the second image received from the parent apparatus to the display device relating to the play form.

2. The game system according to claim 1, wherein
the game processing in the parent apparatus further comprises:
based on the first operation data, selecting an item configured to be selected by a player of the parent apparatus in the game;
based on the second operation data of each of the child apparatuses, selecting an item configured to be selected by a player of the child apparatus in the game; and
causing the game to progress based on each of the selected items,
each of the first image and the second images includes an image representing the item configured to be selected by the corresponding player in the game, and does not include images representing the items configured to be selected by the other players.

3. The game system according to claim 2, wherein
the game is a competition table game, and
the image representing the item configured to be selected by the player is an image of a hand of the player in the competition table game.

4. The game system according to claim 3, wherein
the competition table game is at least any of a card game that uses cards including playing cards, a mahjong game, and a hanafuda game, and
each of the first image and the second images at least includes an image representing cards or tiles in hand of the corresponding player, and does not include an image representing cards and tiles in hand of the other players.

5. The game system according to claim 1, wherein
the game is a game performed in the first or third play form and the communication form in a wireless manner, and
the game processing in the parent apparatus further comprises
generating images based on virtual cameras different from each other in a common virtual space as the first image and the second images.

6. The game system according to claim 5, wherein
the game processing in the parent apparatus further comprises:
identifying positional relationships between the plurality of information processing apparatuses; and
generating the first image and the second images based on the virtual cameras placed in accordance with the positional relationships.

7. The game system according to claim 6, wherein
each of the plurality of information processing apparatuses further comprises a touch panel provided in the display device included in the information processing apparatus,
the game processing in each of the child apparatuses further comprises
transmitting child apparatus touch input data relating to an input to the touch panel of the child apparatus to the parent apparatus, and
the game processing in the parent apparatus further comprises:
acquiring parent apparatus touch input data relating to an input to the touch panel of the parent apparatus;
acquiring the child apparatus touch input data received from the child apparatus; and
based on the parent apparatus touch input data and the child apparatus touch input data, identifying the positional relationships between the plurality of information processing apparatuses so that if a slide input across the touch panels of the information processing apparatuses is provided, places where the slide input is provided are adjacent to each other.

8. The game system according to claim 1, wherein
each of the plurality of information processing apparatuses includes a proximity sensing section that senses a state where the information processing apparatuses are in proximity to each other, and
the game processing in the parent apparatus further comprises
in accordance with the sensing of the state where the information processing apparatuses are in proximity to each other, starting transmission of the second images to the child apparatuses.

9. The game system according to claim 8, wherein
the proximity sensing section performs the sensing through short-range communication or ultra-wideband wireless communication.

10. The game system according to claim 9, wherein
the game processing in the parent apparatus further comprises
identifying positional relationships between the plurality of information processing apparatuses based on the sensing of the proximity sensing section and generating the first image and the second images based on virtual cameras placed in accordance with the positional relationships.

11. An information processing method performed by an information processing system including a plurality of information processing apparatuses including a parent apparatus and a plurality of child apparatuses, the information processing method causing the information processing system to execute:
in each of the plurality of information processing apparatuses,
among a plurality of play forms,
in a first play form, performing a process relating to an operation input to an operation device included in the information processing apparatus and outputting an image to a display device included in the information processing apparatus,
in a second play form, performing a process relating to an operation input to an operation device externally connected to the information processing apparatus and outputting an image to a display device externally connected to the information processing apparatus, and
in a third play form, performing a process relating to an operation input to the operation device externally connected to the information processing apparatus and outputting an image to the display device included in the information processing apparatus; and
communicating with another information processing apparatus in a plurality of communication forms including transmission and reception via the Internet and in a wireless manner,
in the parent apparatus among the plurality of information processing apparatuses,
regarding a multiplay game in a predetermined play form among the plurality of play forms,
performing the communication with each of the child apparatuses in the communication form set for the game among the plurality of communication forms;
acquiring first operation data based on an input to the operation device relating to the play form;
acquiring second operation data received from each of the child apparatuses;
performing game processing regarding the game based on the first operation data and the second operation data;
generating a first image and a plurality of second images different from the first image based on the game processing;
outputting the first image to the display device relating to the play form; and
transmitting the second images to the child apparatuses, and
in each of the child apparatuses,
performing the communication with the parent apparatus;
transmitting the second operation data based on an input to the operation device relating to the play form to the parent apparatus; and
outputting the second image received from the parent apparatus to the display device relating to the play form.

12. The information processing method according to claim 11, further comprising, in the parent apparatus:
based on the first operation data, selecting an item configured to be selected by a player of the parent apparatus in the game;
based on the second operation data of each of the child apparatuses, selecting an item configured to be selected by a player of the child apparatus in the game; and
causing the game to progress based on each of the selected items, wherein
each of the first image and the second images includes an image representing the item configured to be selected by the corresponding player in the game, and does not include images representing the items configured to be selected by the other players.

13. The information processing method according to claim 12, wherein
the game is a competition table game, and
the image representing the item configured to be selected by the player is an image of a hand of the player in the competition table game.

14. The information processing method according to claim 13, wherein
the competition table game is at least any of a card game that uses cards including playing cards, a mahjong game, and a hanafuda game, and
each of the first image and the second images at least includes an image representing cards or tiles in hand of the corresponding player, and does not include an image representing cards and tiles in hand of the other players.

15. The information processing method according to claim 11, wherein
the game is a game performed in the first or third play form and the communication form in a wireless manner, and
the information processing method further comprises, in the parent apparatus,
generating images based on virtual cameras different from each other in a common virtual space as the first image and the second images.

16. The information processing method according to claim 15, further comprising, in the parent apparatus:
identifying positional relationships between the plurality of information processing apparatuses; and
generating the first image and the second images based on the virtual cameras placed in accordance with the positional relationships.

17. The information processing method according to claim 16, wherein
each of the plurality of information processing apparatuses further comprises a touch panel provided in the display device included in the information processing apparatus,
the information processing method further comprises, in each of the child apparatuses,
transmitting child apparatus touch input data relating to an input to the touch panel of the child apparatus to the parent apparatus, and
the information processing method further comprises, in the parent apparatus:
acquiring parent apparatus touch input data relating to an input to the touch panel of the parent apparatus;
acquiring the child apparatus touch input data received from the child apparatus; and
based on the parent apparatus touch input data and the child apparatus touch input data, identifying the positional relationships between the plurality of information processing apparatuses so that if a slide input across the touch panels of the information processing apparatuses is provided, places where the slide input is provided are adjacent to each other.

18. The information processing method according to claim 11, wherein
each of the plurality of information processing apparatuses includes a proximity sensing section that senses a state where the information processing apparatuses are in proximity to each other, and
the information processing method further comprises, in the parent apparatus,
in accordance with the sensing of the state where the information processing apparatuses are in proximity to each other, starting transmission of the second images to the child apparatuses.

19. The information processing method according to claim 18, wherein
the proximity sensing section performs the sensing through short-range communication or ultra-wideband wireless communication.

20. The information processing method according to claim 19, further comprising, in the parent apparatus,
identifying positional relationships between the plurality of information processing apparatuses based on the sensing of the proximity sensing section and generating the first image and the second images based on virtual cameras placed in accordance with the positional relationships.
